(19) United States
(12) Patent Application Publication
(10) Pub. No.: US 2007/0165938 A1
(43) Pub. Date: Jul. 19, 2007

(54) Pattern inspection apparatus and method and workpiece tested thereby

(75) Inventors: Kenichi Matsumura, Tokyo (JP); Yasuko Saito, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Advanced Mask Inspection Technology Inc., Kawasaki-shi (JP)

(21) Appl. No.: 11/378,644

(22) Filed: Mar. 20, 2006

(30) Foreign Application Priority Data
Jan. 19, 2006 (JP) 2006-010760

(51) Int. Cl. G06K 9/00

(52) U.S. Cl. 382/144

(57) ABSTRACT

A pattern inspection apparatus capable of finding temporary emphatic portions in the process of transfer-and-development simulation of the image of a workpiece being tested is disclosed. This apparatus includes a first storage unit for retaining therein the pattern of an image captured from a workpiece under testing, a simulator for applying transfer/development simulation to the captured image pattern, and a second storage unit for storing the pattern of an image which is being presently simulated during the transfer/development simulation of the originally captured image pattern. A comparison processor handles as a pattern to be tested a pattern of the presently simulated or “midstream” image of the captured image while using a pattern to be compared as a fiducial pattern and compares the to-be-tested image to the fiducial pattern. A pattern inspection method is also disclosed.

### CROSS-REFERENCE TO RELATED APPLICATION

This application claims priority to Japanese Patent Application No. 2006-010760, filed Jan. 19, 2006, the disclosure of which is incorporated herein by reference.

### BACKGROUND OF THE INVENTION

1. Field of the Invention

The present invention relates generally to workpiece pattern inspection technologies and, more particularly, to a method and apparatus for inspecting for defects the pattern of a photomask, called “reticle,” which is used in the manufacture of semiconductor devices and liquid crystal display (LCD) panels. This invention also relates to a workpiece tested by the pattern inspection apparatus and method.

2. Description of Related Art

Prior known pattern inspection methodology includes methods for applying simulation processing to a photomask of highly integrated circuit devices to thereby inspect the mask for defects. An example of the inspection methods is disclosed in Published Translated International Application No. 2005-500671. Unfortunately this method as taught thereby suffers from limited inspection capabilities. This can be said because the method is merely designed to inspect a “finalized” pattern after completion of the simulation applied thereto.

With recent advances in miniaturization of semiconductor devices, pattern transfer inspection decreases in margin. This raises a need to perform defect check with precision high enough to permit probing of an exact level of the final transfer margin while fitting inspection conditions to de facto conditions.

Due to this, simply using this technique makes it inevitable to execute margin ascertainment under every possible set of transfer conditions. This would require troublesome and time-consuming data processing and thus lacks practical applicability.

### SUMMARY OF THE INVENTION

It is therefore an object of this invention to provide a pattern inspection method and apparatus capable of performing highly accurate inspection while offering an ability to find emphatic portions of defects temporarily appearing in the process of transfer/development simulation of the image of a workpiece being tested. It is another object of the invention to obtain a workpiece that is tested by the pattern inspection method and apparatus.

Currently preferred embodiments of the invention are arranged to perform simulation processing under ordinary or “standard” process conditions of a workpiece to be inspected, such as a reticle. Pattern inspection is carried out in mid course of the simulation, thereby finding defect candidates on a real time basis. This avoids the need to establish every possible set of process conditions. A high precision level of or “detailed” simulation processing is applied only to such defect candidates thus found, so it becomes possible to achieve inspection with enhanced accuracy. This makes it possible to efficiently check the workpiece for defects. More particularly, but not exclusively, the invention may be implemented in several forms which follow.

In accordance with one aspect of the invention, a pattern inspection apparatus includes a captured image storage unit which stores therein a pattern of an image acquired from an image of a workpiece to be tested, a simulator unit operative to apply transfer/development simulation to the pattern of the acquired image, a simulation image storage unit which stores a pattern of an image obtained in mid course of simulation during the transfer/development simulation of the pattern of the acquired image, and a comparison processor unit that operates to regard as a pattern to be tested the pattern of a during-simulation image of the acquired image while using a pattern to be compared as a fiducial pattern and then compare the to-be-tested image to the fiducial pattern.

In accordance with another aspect of the invention, a pattern inspection method includes the steps of applying transfer/development simulation to the pattern of an image which is acquired from the image of a workpiece to be tested, storing the pattern of an image being presently simulated during the transfer/development simulation of the pattern of the acquired image, and comparing, while letting the presently simulated image be a pattern to be tested and letting a to-be-compared pattern be a fiducial pattern, the to-be-tested pattern to the fiducial pattern.

In accordance with a further aspect of the invention, a workpiece is provided which was obtained by a process including applying transfer/development simulation to the pattern of an image captured from the image of a workpiece to be tested, storing the pattern of an image being presently simulated in mid course of the transfer/development simulation of the pattern of the acquired image, and comparing a pattern of the presently simulated image to a pattern to be compared.

### BRIEF DESCRIPTION OF THE DRAWINGS

FIG. 1 is a diagram showing a configuration of a pattern inspection apparatus embodying the invention.

FIG. 2 shows in detail a hardware configuration of the pattern inspection apparatus.

FIG. 3 is a perspective view of a reticle being scanned for acquisition of a pattern image thereof.

FIG. 4 is a pictorial representation of a system procedure of a pattern inspection method also embodying the invention.

FIG. 5 shows a procedure of transfer/development simulation processing.

FIGS. 6A to 6C are diagrams each showing a change in image pattern during transfer/development simulation.

FIG. 7 shows a process of comparing together the patterns of die images captured (data-to-data or “DD” comparison).

FIG. 8 shows a process of comparing the captured pattern image of a die to the die pattern of a reference image (data-to-database or “DB” comparison).

### DETAILED DESCRIPTION OF THE INVENTION

A workpiece pattern image inspection technique incorporating the principles of this invention will be set forth below. The workpiece to be tested here is a reticle as an example.

Principally the pattern inspection embodying the invention is a process which includes the steps of acquiring the optical image of a workpiece being tested, applying transfer/development simulation processing to the pattern of such optical image under specified process conditions, and inspecting more than one pattern which is obtained in mid course of the transfer/development simulation to thereby examine whether abnormal patterns such as defective pattern portions are present or not. During transfer/development simulation of the image, it can sometimes happen that its defective portions are temporarily emphasized. By finding such emphasized defects, it is possible to perform pattern inspection with enhanced accuracy. For example, suppose that an abnormal pattern is found by inspection of a pattern in mid course of the transfer/development simulation. In this case, store it as a “candidate” of defective part, and then continue and complete the transfer/development simulation with respect to defect candidates only. As for certain locations at which no abnormal patterns are found, interrupt the transfer/development simulation. Then, inspect the finally processed pattern to determine whether the abnormal pattern is a “true” defective portion or not. Alternatively, inspect a pattern being presently subjected to simulation. If an abnormal pattern is found then store it as the candidate of a defective portion. Next, apply the transfer/development simulation only to such abnormal pattern under more precise process conditions than the specified process conditions. For the remaining portions whereat no abnormal patterns are found, halt the transfer/development simulation or, alternatively, apply thereto the transfer/development simulation under the specified process conditions. With these processes, it is possible to lessen the arithmetic computation amount of the transfer/development simulation, thereby making it possible to efficiency inspect the workpiece pattern for defects with increased accuracy. In addition, by executing the transfer/development simulation to its end, it becomes possible to reduce or “curtail” defect candidates. This makes it possible to achieve the screening of the defect candidates.

The optical image may be a pattern image which is captured by an optical image acquisition unit. Note that although the description assumes the handling of optical images, the invention should not be exclusively limited thereto and may alternatively be other types of pattern images acquired by non-contact or contact means. Examples of the images include, but not limited to, a laser beam-scanned image, an observational image obtainable by scanning electron microscope (SEM) equipment, an image obtained by scanning tunneling microscope (STM) tools, an image gained by non-contact interatomic force (NC-AF) means, and an X-ray sensed image. Additionally the above-stated transfer/development simulation processing may be known simulation scheme-based image manipulation, such as transfer simulation and/or development simulation or else. The transfer/development simulation is performed with settings of a variety of process conditions, such as exposure and etching conditions. The process conditions include various ones such as short-time rough processing conditions, long-time precise processing conditions or else. Although the description assumes that the workpiece being tested is a reticle, the workpiece may alternatively be other objects as far as these have a surface on which a pattern is formed for use in the manufacture of semiconductor devices and LCD panels, such as for example photomasks, wafers, etc. The term “pattern” as used herein should be interpreted to mean an entire pattern or a partial pattern.

### Pattern Inspection Apparatus

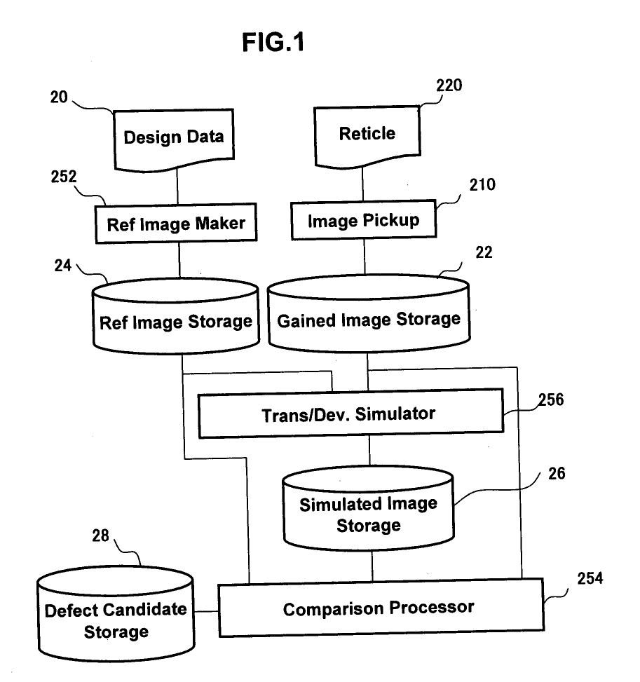

Referring to FIG. 1, an overall configuration of a pattern inspection apparatus embodying the invention is shown. This pattern inspection apparatus is generally made up of an optical image acquisition unit 210, a sensed image storing unit 22, a transfer and development simulation processing unit 256, a simulation image storing unit 26, a comparison processing unit 254, a reference image creating unit 252, a reference image storage unit 24, and a defect candidate storage unit 28. The storage unit 22, 24, 26 or 28 may be a semiconductor memory, hard disk drive (HDD) or any equivalents thereto. The image acquisitor 210 is operable to sense and capture the image of a pattern which is drawn on a workpiece to be inspected, such as a reticle 220. The image storage unit 22 stores therein the captured image, i.e., a sensed image of the pattern on the reticle 220. The simulator 256 applies transfer-and-development simulation processing to the pattern of an image sensed. The simulation image storage 26 stores the pattern of an image obtained in mid course of the transfer/development simulation, that is, the pattern of an image acquired at an instant during execution of the simulation. The comparison processor 254 performs comparison of a plurality of patterns. More specifically, it performs comparison between a pattern to be tested and a fiducial or “base” pattern for testing while regarding the pattern of a during-simulation image as the to-be-tested image and letting a to-be-compared pattern be the fiducial pattern. Examples of the to-be-compared pattern are the pattern of an image acquired, another pattern of the during-simulation image (e.g., the pattern of another die in the same reticle) and the pattern of a reference image of reticle 220. The reference image creator 252 prepares from the reticle 220's design data 20 a reference image which has much similarity to the optical image of interest. The reference image storage 24 stores therein the reference image thus created. The defect candidate storage 28 stores as a defect candidate a defective portion of the pattern as found at the comparison processor 254. Note here that the pattern inspection apparatus may comprise extra components in addition to those shown in FIG. 1 or alternatively may be designed so that one or some units are excluded from the configuration of FIG. 1 as far as the intended pattern inspectability is achievable. An example is that the pattern inspection apparatus is configured without the reference image creator 252 and reference image storage 24 in cases where this apparatus does not make use of the reference image as the pattern to be compared. The to-be-tested pattern and fiducial test pattern are mere names for making the both distinguishable over each other, and these names may be interchanged with each other in a way such that the pattern of a during-simulation image may be called the fiducial pattern whereas the to-be-compared pattern may be called the to-be-tested pattern.

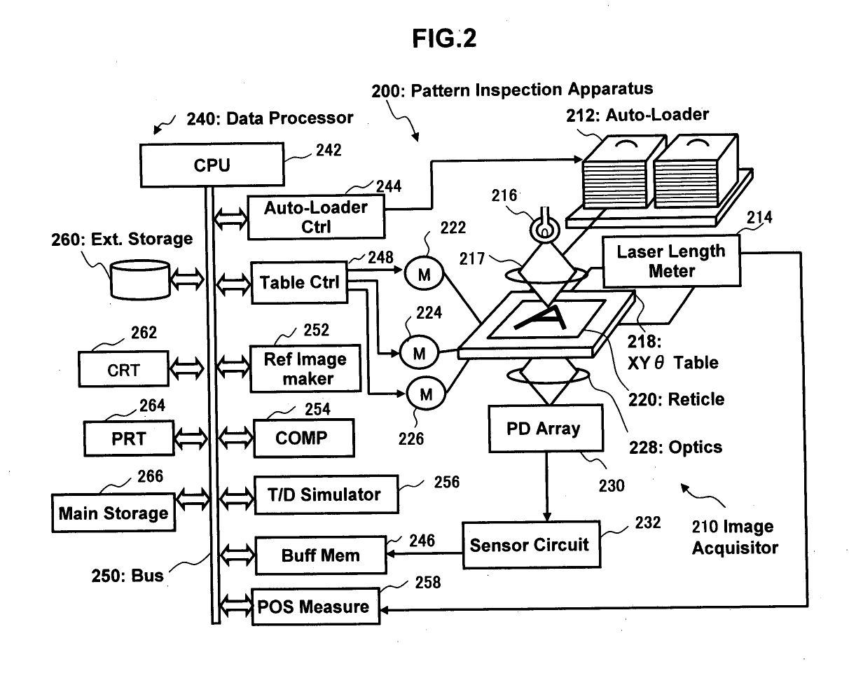

An exemplary system configuration of pattern inspection apparatus 200 is shown in FIG. 2. This inspection apparatus 200 includes an optical image acquisition unit 210 and a data processing unit 240. The image acquisitor 210 is generally made up of an auto-loader 212, light source 216, light irradiation unit 217, XYθ table 218 which mounts thereon reticle 220, θ-axis motor 222, X-axis motor 224, Y-axis motor 226, laser-assisted length measurement system 214, magnifying optical lens assembly 228, photodiode (PD) array 230, and sensor circuit 232. The data processor 240 includes a central processing unit (CPU) 242, bus 250 for transmission of data and programs, auto-loader control unit 244, table controller 248 for control of the XYθ table 218, reference image creation unit 252 which creates a reference image that resembles an optical image, comparison processor unit 254 for comparing between images to determine or “judge” defects, simulator 256 which applies simulation—such as transferring, development, etc.—to the optical image and/or the reference image, buffer memory 246, and position measurement unit 258 responsive to the data from the laser-assisted length meter 214 for obtaining a present table position. The pattern inspection apparatus also includes a main storage device 266 and external storage device 260, which are for storing various kinds of data and database along with software programs. The main storage 266 has a semiconductor memory device or HDD which achieves functions of the acquired image storage 22, reference image storage 24, simulation image storage 26, and defect candidate storage 28 shown in FIG. 1. The inspection apparatus 200 further includes a cathode-ray tube (CRT) display 262 and a printer machine 264, which are linked to the bus 250. Additionally the apparatus 200 is configurable from electronics circuitry, a software program(s), a personal computer (PC) or any possible combinations thereof.

### Optical Image Acquisition Unit

The optical image acquisition unit 210 functions to capture the optical image of a reticle 220. This reticle 220 is mounted on the XYθ table 218. XYθ table 218 is a three-axis (X-Y-θ) manipulator which is movable in X and Y directions with or without rotation by angle θ under control of the table controller 248, which is operatively responsive to receipt of a command(s) from CPU 242. Table 218 is driven by the X motor 224 in the X direction, by Y motor 226 in Y direction, and by θ motor 222 in θ direction. These motors may be known servo motors, stepper motors or other electrical motors. The coordinates of a present position of XYθ table 218 is measured by the laser length meter 214, an output signal of which is sent to the position measurement unit 258. Output position coordinate data of this unit 258 is fed back to the table controller 248.

The reticle 220 is automatically transferred to and mounted on the XYθ table 218 by auto-loader 212 and, after inspection, automatically unloaded thereby. The light source 216 and light irradiation unit 217 are located over XYθ table 218. The light source 216 emits light, which is guided by a condenser lens assembly of the light irradiator 217 to fall onto the reticle 220 as a focused light beam. At a location underlying the reticle 220, a signal detection unit is disposed, which includes the magnifying optics 228 and PD array 230. The light that passed through reticle 220 is focused by magnifier optics 228 onto a photosensitive surface of PD array 230. The optics 228 is subjected to automatic focus adjustment by a focus adjuster device (not shown), which includes piezoelectric elements or the like. This focus adjuster is operation-controlled by an auto-focus control circuit (not shown), which is connected to the CPU 242. The focus adjustment may alternatively be monitored by a separately provided observation scope. The PD array 230 for use as a photoelectric converter may be a linear array of multiple photosensors or an area sensor having a matrix of rows and columns of PDs. While letting XYθ table 218 move continuously in X direction, PD array 230 detects a measurement signal corresponding to a sensed image of reticle 220.

This measurement signal is converted by the sensor circuit 232 into digital data, which is then passed as the data of the optical image to the buffer memory 246, main storage 266 and external storage 260. The optical image data may be eight (8) bits of sign-less data indicative of the brightness of each picture element or “pixel.” The pattern inspection apparatus 200 of this type is usually operates to read the pattern data out of the PD array 230 in a way synchronous with a clock frequency of about 10 to 30 megahertz (MHz), get them lined up to provide an adequate form of data, and handle as raster-scanned two-dimensional (2D) image data.

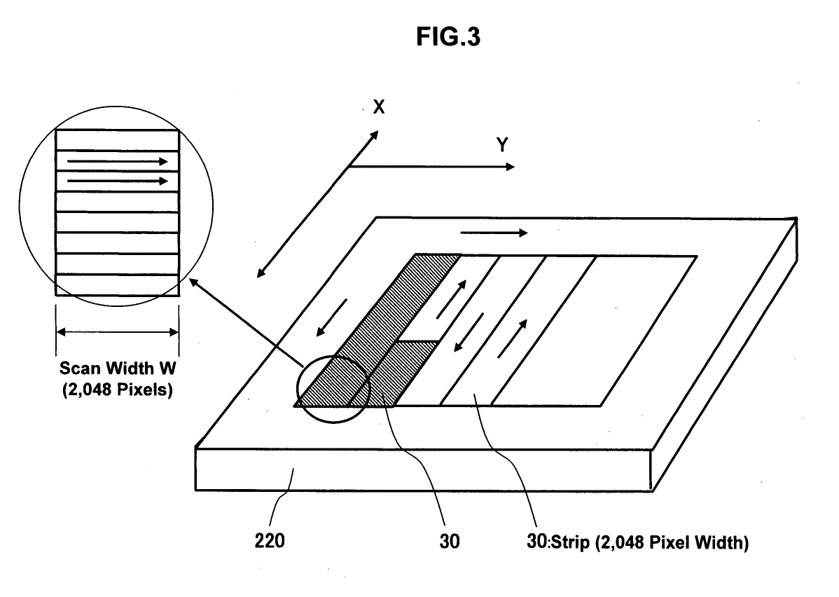

See FIG. 3, which shows an exemplary optical image acquisition procedure. The reticle 220's pattern area to be inspected is virtually divided into a plurality of strip-like narrow rectangular subareas 30 each having a scan width W along the Y direction. To ensure continuous scanning of these divided strips 30, XYθ table 218 is driven to move in the X direction under control of table controller 248. In a way synchronized with such table movement, the light beam scans respective strips 30 so that their optical images are captured by PD array 230. This PD array captures these images of the scan width W continuously or “seamlessly.” Here, the scan width W is set to a length corresponding to a total size of 2,048 pixels as an example.

The measured pattern data of the reticle strips 30 as output from the sensor circuit 232 are sent to the comparison processor 254 along with the output data of position measurement unit 258 indicative of a present position of reticle 220 on XYθ table 218. An optical image to be compared is cut into partial areas of an appropriate size; for example, regions each having a matrix of 512 by 512 pixels. Although the optical image is captured here by using the light that passed through reticle 220, similar results are obtainable by use of reflection light, scattered light, polarized scatter light, polarized transmission light or else. To detect these image light rays, the image acquisitor 210 has a built-in image capturing mechanism for pick up of the images of these rays.

### Making Reference Image

A reference image is an image that was prepared to have much similarity to the optical image by execution of various conversion processes from the design data of the reticle 220. The reference image is preparable, for example, by the reference image creator 252 in a way which follows. Access is given to either the external storage 260 or the main storage 266 to read therefrom the design data of the pattern image of reticle 220 under control of CPU 242. Then, convert the read data into image data. Next, perform image resembling processing—e.g., rounding corner edges of graphic forms, gradating or “fogging,” or other similar suitable image manipulation—to thereby create the reference image. The reference image thus created is stored in the external storage 260 or internal main storage 266.

### Comparison Processor

The comparison processor 254 compares between images to determine whether defects are present or absent. There are several approaches to doing image comparison, one of which is die-to-die (DD) comparison, and another of which is die-to-database (DB) comparison. The DD comparison is to compare a die on a reticle to another on the reticle. The DB comparison is for comparing a die on reticle to a reference image. The DD and DB comparison schemes include a process of detecting a change in transmissivity, foreign matter attachment, ultrafine edge positions or ultrasmall intensity variation. The comparison processor 254 enables achievement of more accurate deterioration testing by performing comparison of micro-shapes such as contact holes, setup of a margin pursuant to the materiality of graphic figure, and setting of area sensitivity depending on graphics features.

### Pattern Inspection Method

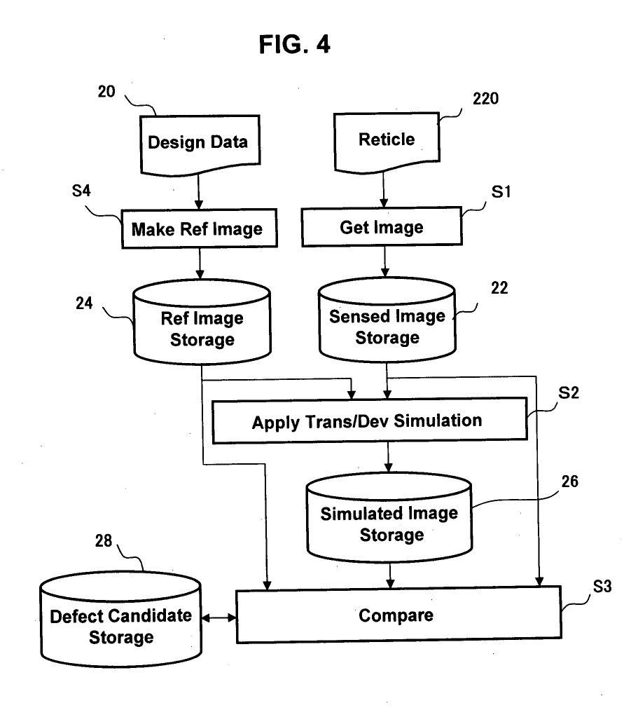

See FIG. 4, which shows a pattern inspection method also embodying the invention. This method starts with step S1, which causes the image acquisitor unit 210 to sense and capture an optical image of the reticle 220 of interest, which image is stored in the image storage 22. Then, the procedure goes to step S2 which permits the simulator 256 to read the captured image out of the storage 22 and apply transfer/development simulation to the pattern of captured image to thereby obtain a pattern of resultant image with the transfer/development simulation applied thereto, which pattern is stored in image storage 26. Next, at step S3, the comparison processor 254 reads the simulation image from storage 26 and compare it to the pattern of an object to be compared. If a comparison result reveals that a pattern difference therebetween is in excess of a predefined threshold level, then determine it as a defect, which is stored in the defect candidate storage 28. Examples of the to-be-compared pattern are the pattern of the captured image, another pattern of the simulation image, a pattern of another simulation image, and a pattern of reference image of the workpiece being tested.

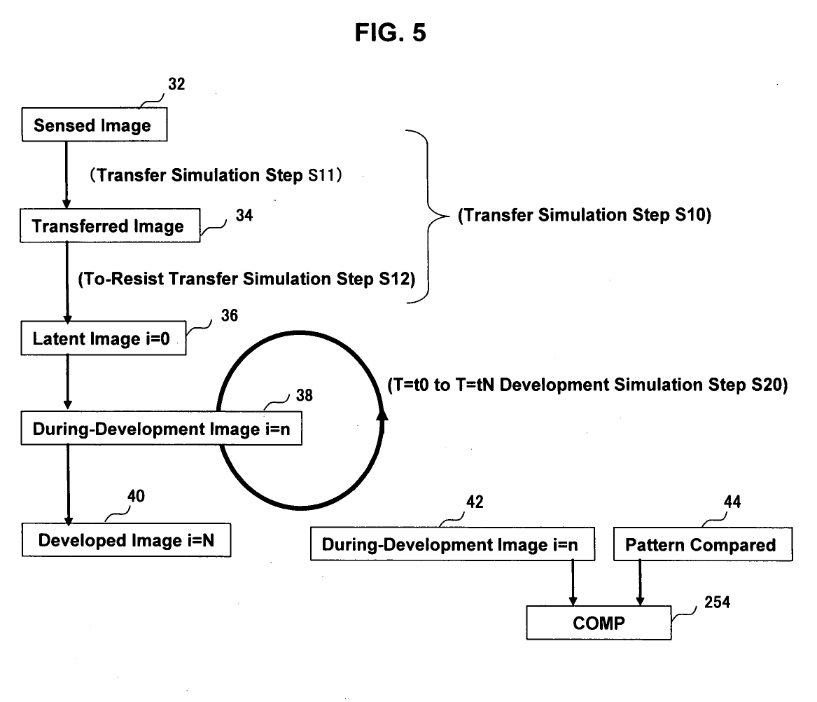

Referring to FIG. 5, a system procedure in the transfer/development simulation processing is shown, which is for comparing together a pattern 42 of a during-simulation image in mid course of the transfer/development simulation and a pattern 44 to be compared. This procedure starts with step S10, which applies optical transfer simulation to a captured image 32 as obtained from the image of reticle 220. More specifically, perform optical transfer simulation at step S11 to form the pattern of a transferred image 34. Then at step S12, apply to this image 34 the simulation of transferring onto a resist, thereby virtually forming a latent image (i=0) 36. Next at step S20, perform for the latent image 36 a plurality of stages of development simulation operations (i=1, 2, . . . , n, . . . , N) at time points t0, t1, t2, . . . , tN with the elapse of a total time T. During this simulation, prepare an n-th developed image in mid course of the development (i=n) 38, which is called the during-simulation image. Finally, make a development result image (i=N) 40. Subsequently, let the comparison processor 254 compare the pattern of during-simulation image (i=n) 42 to the to-be-compared pattern 44, thereby performing inspection for defects. Note here that the above-noted transfer simulation step S10 and development simulation step S20 make up the transfer/development simulation step S2 shown in FIG. 4.

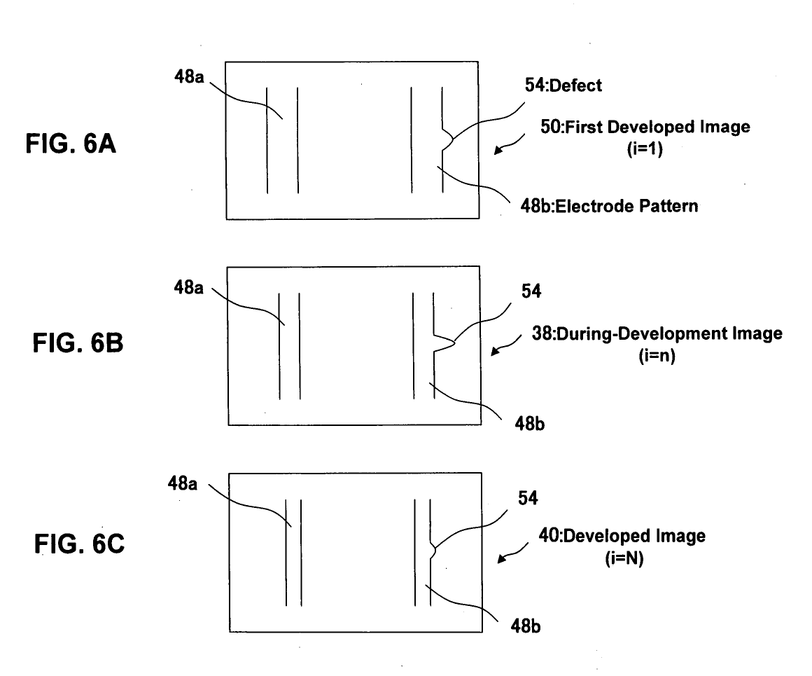

FIGS. 6A to 6C show exemplary images of a captured die image having two electrode patterns 48a and 48b on its opposite sides, which images are sequentially obtained at different time points during the transfer/development simulation applied thereto. More precisely, FIG. 6A pictorially shows an initial or “primitive” development image of the die having electrode patterns 48a-48b. The right side electrode pattern 48b has a defective portion 54. FIG. 6B shows a during-development image 38 with the electrode patterns 48a-48b. As shown herein, these electrode patterns 48a-b are each decreased in width, resulting in emphatic appearance of the defective portion 54 at the right side electrode pattern 48b. FIG. 6C shows the development-resulted image 40. The electrode patterns 48a-b become further thinner, resulting in the defect 54 of right side electrode pattern 48b shrinking in size. As apparent from the foregoing, the defect 54 takes place with increased visual emphasis in mid course of the transfer/development simulation at step S2; however, it happens that such defect appearance becomes weak or “degenerates” after the final stage of the simulation processing.

### EXAMPLE 1

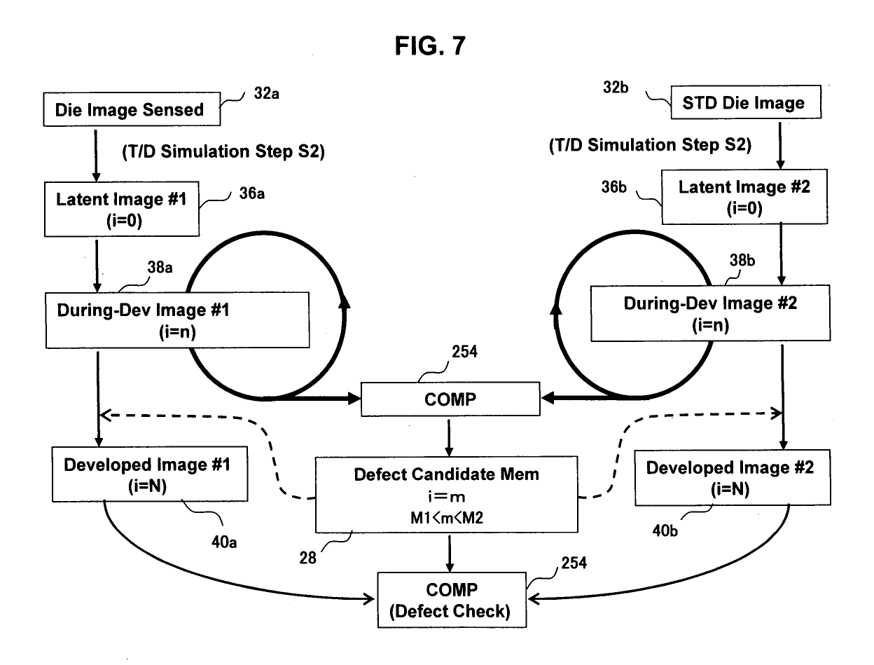

Turning to FIG. 7, an exemplary procedure at the transfer/development simulation step S2 of FIG. 4 is shown, which performs DD comparison of a couple of dies 32a and 32b in a pattern image acquired from the reticle 220 being in mid course of transfer/development simulation while letting one of these dies, 32a, be the pattern image to be tested and letting the other die 32b be a fiducial or “base” pattern image. The procedure shown herein starts with a step which applies the same transfer/development simulation to both the to-be-tested die 32a and the fiducial die 32b, thereby to form a to-be-tested pattern and a fiducial pattern of latent images 36a and 36b of the tested die 32a and fiducial die 32b. Then, apply transfer/development simulation to these tested and fiducial patterns of the latent images 36a-36b of dies 32a-32b. At a time point (i=n) in mid course of the transfer/development simulation step S2, let the comparison processor 254 compare together the patterns of during-the-process or “midstream” images 38a and 38b of the tested die 32a and fiducial die 32b. If a difference therebetween is greater than a predetermined threshold value (for example, in case it becomes larger within a range of M1<m<M2 when i=m), then store in the defect candidate storage 28 one or more portions specified as the defect candidates of the tested die 32a and fiducial die 32b as the result of detection of a local minimal difference. For these defect candidates only, perform and complete the transfer/development simulation to the very end thereof. Then, compare together development-resulted images (i=N) of dies 32a-32b at the comparison processor 254. More specifically, these developed images 40a-40b are processed so that comparator 254 makes a final decision as to whether a defect(s) is/are found in the images of dies 32a-32b while establishing one-to-one correspondence in position between these “final” defects and the defect candidates as detected in mid course of the process at the transfer/development simulation step S2. With this processing, it is possible to reduce in number the defective candidates by excluding false ones therefrom while increasing the certainty of the “screening-passed” candidates.

### EXAMPLE 2

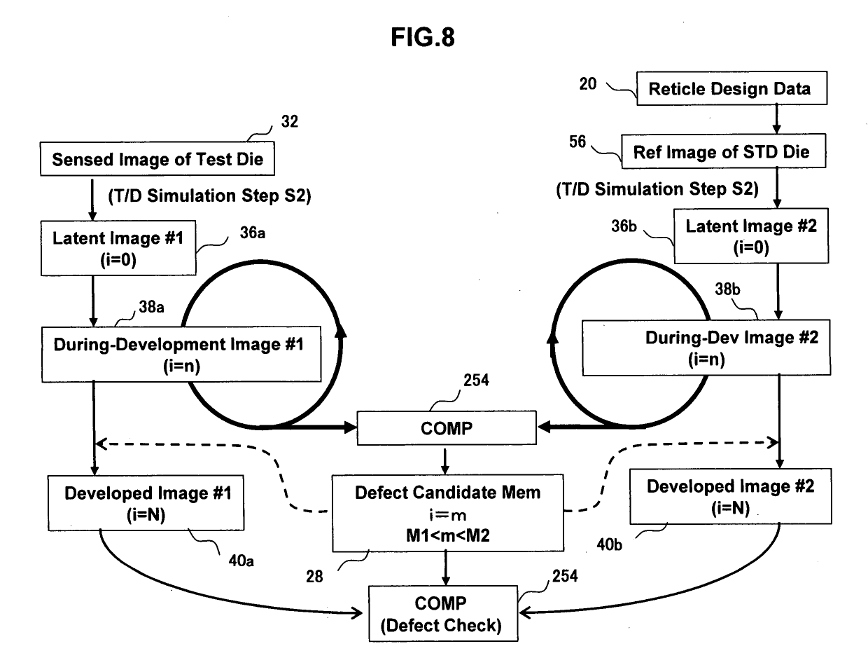

Another exemplary procedure is shown in FIG. 8. This procedure includes applying transfer/development simulation to a sensed image 32a of to-be-tested die on the reticle 220 and a reference image 56 as created from the design data of a fiducial die of reticle 220 and performing DB comparison between the to-be-tested pattern of a midstream image 38a and the fiducial pattern of a midstream image 38b, which are obtainable at the transfer/development simulation step S2 of FIG. 4. This example is similar to that shown in FIG. 7 except that the fiducial pattern used in the former is a reference image. Regarding the other process steps also, these are the same in principle as those of FIG. 7.

While this invention has been described with reference to specific embodiments, the description is illustrative of the invention and is not to be construed as limiting the invention. The invention is, therefore, to be limited only as indicated by the scope of the appended claims.

What is claimed is:

1. A pattern inspection apparatus comprising:
a first storage unit operative to store therein a pattern of an image acquired from an image of a workpiece to be tested;
a simulator unit operative to apply transfer/development simulation to the pattern of the acquired image;
a second storage unit for storing one or more during-simulation image patterns in mid course of the transfer/development simulation of the acquired image pattern; and
a comparison processor unit operative to regard as a pattern to be tested a during-simulation image pattern of said acquired image while using a pattern to be compared as a fiducial pattern and compare the to-be-tested image to the fiducial pattern.

2. The apparatus according to claim 1, wherein said fiducial pattern is any one of the acquired image pattern, another during-simulation image pattern, a pattern of a during-simulation image of another acquired image, a pattern of a reference image of the to-be-tested workpiece, and a pattern of a during-simulation image of the reference image.

3. The apparatus according to claim 1, wherein said fiducial pattern is any one of another during-simulation image pattern of said acquired image, a during-simulation image pattern of another acquired image, and a during-simulation image pattern of a reference image of the to-be-tested workpiece, and wherein said apparatus further comprises:
a third storage unit operative to store as a defect candidate a pattern with a difference between the to-be-tested pattern and the fiducial pattern being greater than or equal to a threshold.

4. A pattern inspection method comprising:
applying transfer/development simulation to an image pattern acquired from an image of a workpiece to be tested;
storing more than one during-simulation image pattern obtained in mid course of the transfer/development simulation of the acquired image pattern; and
while letting the during-simulation image pattern be a pattern to be tested and using a pattern to be compared as a fiducial pattern, comparing the to-be-tested pattern to the fiducial pattern.

5. The method according to claim 4, wherein said fiducial pattern is any one of the acquired image pattern, another during-simulation image pattern, a pattern of a during-simulation image of another acquired image, a pattern of a reference image of the to-be-tested workpiece, and a pattern of a during-simulation image of the reference image.

6. The method according to claim 4, wherein said fiducial pattern is any one of another during-simulation image pattern of said acquired image, a during-simulation image pattern of another acquired image, and a during-simulation image pattern of a reference image of the to-be-tested workpiece, and wherein said method further comprises:
storing as a defect candidate a pattern with its difference from the fiducial pattern being greater than or equal to a threshold.

7. The method according to claim 4, wherein said fiducial pattern is any one of another pattern of the during-simulation image, a during-simulation image pattern of another acquired image, and a during-simulation image pattern of a reference image of the to-be-tested workpiece, and wherein said method further comprises:
when a pattern is found with a difference between the to-be-tested pattern and the fiducial pattern being greater than or equal to a threshold, continuing execution of said transfer/development simulation only for the pattern with its difference being greater than or equal to the threshold.

8. The method according to claim 4, wherein said fiducial pattern is any one of another during-simulation image pattern, a during-simulation image pattern of another acquired image, and a during-simulation image pattern of a reference image of the to-be-tested workpiece, said method further comprising:
when a difference between the to-be-tested pattern and the fiducial pattern is greater than or equal to a threshold, continuing execution of said transfer/development simulation only for a pattern with its difference being more than or equal to the threshold under a process condition being higher in precision than the transfer/development simulation prior to execution of comparison processing.

9. A workpiece as obtained by a process including applying transfer/development simulation to an image pattern acquired from an image of a workpiece to be tested, storing a pattern of an image being presently simulated in mid course of the transfer/development simulation of the acquired image pattern, and comparing the pattern of the presently simulated image to a pattern to be compared.
